(19) United States
(12) Patent Application Publication
(10) Pub. No.: US 2012/0158553 A1
(43) Pub. Date: Jun. 21, 2012

(54) Method and System for Inventory Management Over a Peer-To-Peer Network

(76) Inventors: Yodchai Sudhidhanakul, Samut Prakarn (TH); Zoran Naskov, Rutherfordton, NC (US); Ludvik Olason, Selfoss (IS); Gabriel Weisskopf, Zollikon (CH)

(21) Appl. No.: 12/971,611

(22) Filed: Dec. 17, 2010

(51) Int. Cl. G06Q 10/00; G06Q 30/00

(52) U.S. Cl. 705/28

(57) ABSTRACT

Present invention embodiments pertain to managing inventory via a peer-to-peer (P2P) infrastructure. Inventory owners or providers employ modules (tailored to the type of inventory owned or provided) to automatically store the definition of the products and/or services of the inventory on the inventory provider computer system. Once the inventory is defined, the inventory provider computer system may automatically join a peer-to-peer (P2P) network, and publishes information about the inventory to enable access and transactions by other participants in the peer-to-peer network. The peer-to-peer network includes several different types of participating nodes with each node interconnected via encrypted links over the public Internet.

### BACKGROUND

1. Technical Field

The present invention generally relates to systems, methods, and components used for computer-based inventory management systems. The present invention is particularly suited to inventory management systems and procedures for managing an inventory of items having time or other resource constraints as to availability of the item in the inventory.

2. Discussion of the Related Art

A centralized database management system is frequently employed for managing inventory of many types of products and/or services. Generally, an inventory owner or provider creates a database on one or more server computer systems and populates that database with records associated with information pertaining to items in the inventory. The status and availability of items in the inventory is managed by changing information contained in records in the database. Often, these server systems are made accessible over the Internet to consumers for purchase or rental of items in the inventory. Further, the inventory providers may access the server systems to update the inventory maintained by those systems.

However, this centralized scheme tends to be expensive since inventory providers generally must pay for and maintain fully integrated server systems to host and manage the inventory and to conduct transactions. These systems often demand substantial committed physical resources and a substantial investment in network and computing infrastructure. In addition, access to the inventory may be hindered at various times due to unpredictable network traffic and constraints on capacity relative to the number of potential users seeking to access the inventory information from one or more common server systems. Moreover, fully integrated inventory management systems tend to be limited in their capacity to readily interface with world wide web and other public network environments.

### BRIEF SUMMARY

The present invention overcomes problems with fully-integrated and standalone inventory management systems known in the art. The present invention does this using systems, components and procedures that manage inventories of items, particularly those having time and other resource constraints. The invention further enables one to publish information concerning the inventory on a real-time basis via a peer-to-peer (P2P) network infrastructure, and enables transactions to be made concerning the items in the inventory. In general, the present invention does this via (i) a peer-to-peer client capable of tracking the inventory of items, particularly time or resource-constrained items, where such peer-to-peer client also publishes information concerning the inventory to other clients in the environment and to the public Internet, and (ii) super nodes that function to interrelate the peer-to-peer client nodes and optionally provide additional administrative or management functions. In addition, the system comprises Application Programming Interfaces (APIs) and other interface elements that enable interactions with the peer-to-peer network via the public Internet and other networks.

The types of inventories that are particularly suited to the present invention include items having time or other resource constraints (e.g., items that are available only for defined periods of time, items having conditions attached to availability and/or use of the item). By way of example only, these particularly preferred types of inventories include: services that can be booked in advance (e.g., guided tours, restaurant reservations, hotel rooms, car rentals, airline seats and the like), rentals of physical items (e.g., rental of vacation properties, rentals of apartment or other dwelling units, rental of commercial real estate, rental of machines or equipment, and the like), sale of retail or wholesale products, particularly those having a time sensitivity (e.g., cars, clothing, parts produce, and the like), or any other product and/or service.

Pursuant to the invention, inventory owners or providers deploy software and/or other modules (tailored to the type of inventory owned or provided) that automatically store the definition of the products and/or services of the inventory on the inventory provider computer system. Once the inventory is defined and established on the inventory provider computer system, the inventory provider computer system automatically joins a peer-to-peer (P2P) network having the same or different set of defined inventory features, and publishes information about the inventory. The peer-to-peer client, once it begins to participate in the peer-to-peer network, thereby enables access by other participants in the peer-to-peer network to the inventory being published by the inventory provider computer system. The Internet connection of the inventory provider computer system is utilized to maintain an active connection to the peer-to-peer network. This connection further enables access to the inventory stored on the inventory provider computer system by consumers interested in requesting or purchasing the services and/or products of the inventory. The peer-to-peer network includes several different types of participating nodes with each node interconnected via encrypted links over the public Internet. The encrypted communication within the peer-to-peer network is limited to the network participants.

The present invention provides several advantages. For example, the user interface may be tailored or customized based on the market segment, deployment partners and other factors, while remaining a part of the network of inventory nodes. The module providing the user interface is separate from a module providing processing and communications in order to facilitate easy integration of the customized interfaces. The inventory may be operated on a user's device and migrated to and from a central location without leaving the peer network, and without taking the inventory offline. The type of time sensitive inventory data that may be managed and distributed targets markets and users in areas where physical inventory doesn't apply (e.g., hotels, bed and breakfasts, service reservations, etc.). Further, the encryption and restricted participation in the network allows for an easy to deploy and easy to control peer network. Moreover, the credit based transaction restriction employed by the network allows for a revenue model which typically would not be possible in a general peer-to-peer system. The network processes payments, and delivers automated notifications to end inventory users when their transactions are complete. In addition, inventory pricing may be defined with highly advanced pricing features (e.g., advance purchase, seasonality, discounts, inventory level pricing, etc.).

### BRIEF DESCRIPTION OF THE DRAWINGS

FIG. 1 is a diagrammatic illustration of an example peer-to-peer network topology according to an embodiment of the present invention.

FIG. 2 is a block diagram of an inventory peer module according to an embodiment of the present invention.

FIG. 3 is a schematic illustration of an example graphical user interface screen for entering inventory information according to an embodiment of the present invention.

FIG. 4 is a schematic illustration of another example graphical user interface screen for entering inventory information according to an embodiment of the present invention.

FIGS. 5A-5B are a procedural flow chart illustrating the manner in which an inventory owner or provider enters inventory information according to an embodiment of the present invention.

FIGS. 6A-6B are a procedural flow chart illustrating the manner in which inventory information is made available when a corresponding inventory peer node is offline according to an embodiment of the present invention.

FIG. 7 is a procedural flow chart illustrating the manner in which inventory information is protected against catastrophic data loss according to an embodiment of the present invention.

FIG. 8 is a procedural flow chart illustrating the manner in which consumers are provided access to the inventory information according to an embodiment of the present invention.

FIG. 9 is a procedural flow chart illustrating the manner in which consumers access the inventory information from inventory peer nodes according to an embodiment of the present invention.

FIG. 10 is a procedural flow chart illustrating the manner in which a consumer may select an inventory peer node and access inventory information published on the peer-to-peer network according to an embodiment of the present invention.

FIG. 11 is a procedural flow chart illustrating the manner in which consumers access the inventory information via a legacy channel according to an embodiment of the present invention.

FIGS. 12A-12B are a procedural flow chart illustrating an example manner in which a consumer may purchase inventory published on the peer-to-peer network according to an embodiment of the present invention.

### DETAILED DESCRIPTION OF EXAMPLE EMBODIMENTS

The present invention pertains to systems, components and procedures for managing (e.g., describing, publishing, distributing, marketing, booking, purchasing, etc.) inventory via a peer-to-peer (P2P) infrastructure. The type of inventory, by way of example, may include: simple personal items for sale (e.g., online auctions, etc.), services that can be booked in advance (e.g., guided tours, restaurant reservations, hotel rooms, car rentals, airline seats, etc.), retail or wholesale products (e.g., cars, clothing, parts, etc.), or any other product and/or service. Inventory owners or providers may publish information concerning their inventory to the peer-to-peer infrastructure (and/or non peer-to-peer infrastructures) immediately via their own computer system and at significantly reduced costs relative to a centralized approach (e.g., a central server system hosting the information) that incurs significant costs for hosting the information. This enables owners or providers of smaller inventories with reduced capital to make that inventory available to a network of consumers at affordable costs.

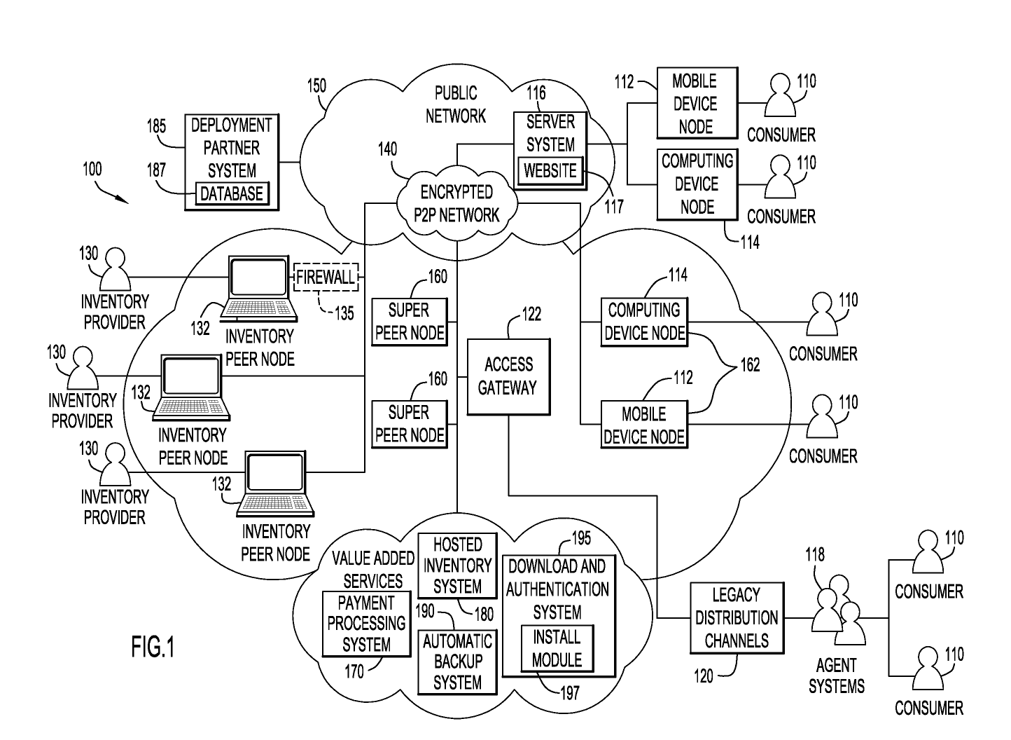

An example peer-to-peer (P2P) network topology or infrastructure according to an embodiment of the present invention is illustrated in FIG. 1. Specifically, peer-to-peer network 100 includes one or more inventory peer nodes 132, one or more various mobile and/or computing device nodes 112, 114 (e.g., mobile devices, personal or other computer systems), and one or more super nodes 160. Inventory peer nodes 132 enable corresponding inventory owners or providers 130 to access the peer-to-peer network and publish information concerning their inventory. Mobile and computing device nodes 112, 114 enable corresponding consumers 110 to access the peer-to-peer network and search and conduct transactions concerning the published inventory. The communication between the nodes of the peer-to-peer network for published information provides always current and up to date information on inventory despite the fact that the inventory information is constantly and dynamically changing due to the numerous inventory transactions or operations (e.g., adding or updating inventory, purchasing of inventory, etc.) being performed in the network. In other words, one of the advantages of the peer-to-peer inventory management infrastructure of the present invention includes enabling users to receive “live” or real-time information concerning the inventory being published (e.g., information is provided in a constantly or dynamically changing manner at the point in time an information request is processed), thereby eliminating, or significantly minimizing, the distribution of stale or outdated information (e.g., outdated by even a small time interval).

Inventory peer nodes 132, mobile and computing device nodes 112, 114, and super nodes 160 communicate with each other via a network 150. The network is preferably implemented by a public wide area network (WAN) (e.g., the Internet), but may be implemented by any suitable network or other communications media (e.g., WAN, LAN, Intranet, Internet, etc.). Network 150 includes an encrypted peer-to-peer (P2P) network 140 that provides encrypted communication between participants of peer-to-peer network 100. Thus, participants of peer-to-peer network 100 communicate over the public Internet using encrypted communication messages. Network 140 typically includes one or more server or other computer processing systems for encryption of the communications, where any conventional or other encryption scheme may be employed.

Inventory information (e.g., information pertaining to the inventory, transactions for the inventory, bookings, reservations, payments, cancellations, etc.) may further be accessed by third party groups or legacy distribution channels, and web browser users. In particular, peer-to-peer network 100 includes a server system 116, and an access gateway 122 coupled to legacy distribution channels 120. Server system 116 hosts a web site 117 accessible to mobile and computing device nodes 112, 114 that enable a consumer 110 to access the inventory information on the peer-to-peer network as described below. Gateway access 122 and legacy distribution channels 120 enable third party groups to provide access to the peer-to-peer network for consumers 110 through agent systems 118 as described below. The access gateway and server system are coupled to network 140 to enable the access gateway and web site accesses to be similarly conducted via the encrypted communications of the peer-to-peer network.

In addition, peer-to-peer network 100 may provide additional services and include a payment processing system 170 to handle payments, a hosted inventory system 180 to host inventory information, a backup system 190 to backup information, and a download and authentication system 195 to provide modules for downloading and authenticate inventory providers as described below.

The various nodes and systems of the peer-to-peer network (e.g., inventory peer nodes 132, server systems, mobile and computing device nodes 112, 114, server system 116, gateway access 122, super node 160, payment processing system 170, hosted inventory system 180, backup system 190, authentication system 195, etc.) include one or more inventory modules or units to perform network and/or other functions. The inventory modules may be implemented by any combination of hardware and/or software modules or units. Each node in the peer-to-peer network has a specific role in enabling the flow of inventory information and maintaining connections between network participants.

The various nodes and systems of the peer-to-peer network (e.g., inventory peer nodes 132, encryption or other server systems, mobile and computing device nodes 112, 114, server system 116, super node 160, payment processing system 170, hosted inventory system 180, deployment partner system 185, backup system 190, authentication system 195, etc.) may be implemented by any conventional or other computing systems or devices preferably equipped with a display or monitor, a base (e.g., including the processor, memories and/or internal or external communications devices (e.g., modem, network cards, etc.)), optional input devices (e.g., a keyboard, mouse or other input device), and any commercially available and/or custom software (e.g., server/communications software, one or more inventory modules, browser/interface software, etc.). In addition, the inventory modules may include one or more modules or units to perform the various functions described below (e.g., managing inventory information over a peer-to-peer network, etc.), and may be implemented by any combination of any quantity of software and/or hardware modules or units.

The peer-to-peer network enables multiple providers of inventory to provide access to a composite of the multiple inventories being published and made accessible by each peer-to-peer node to interested consumers via the one or more inventory modules residing on the inventory peer node. This capacity to present aggregated inventories that are maintained in a real-time and constantly updating basis to interested users is a particular benefit of the present invention. For particular types of time or resource constrained items (e.g., rental properties or hotel rooms), the aggregated inventories are made available pursuant to use of the present invention in a manner that offers significant efficiencies and benefits to parties interested in the items in the inventories. Thus, for example, rooms for rent in hotels or bed and breakfast facilities found in various distinct inventories within a particular geographical region can be presented to parties interested in renting such rooms via a simple unified interface, either graphically or otherwise. The aggregated inventories are maintained in a constantly updated state and automatically published on a real-time and constantly updating basis by the individual peer-to-peer node implementations.

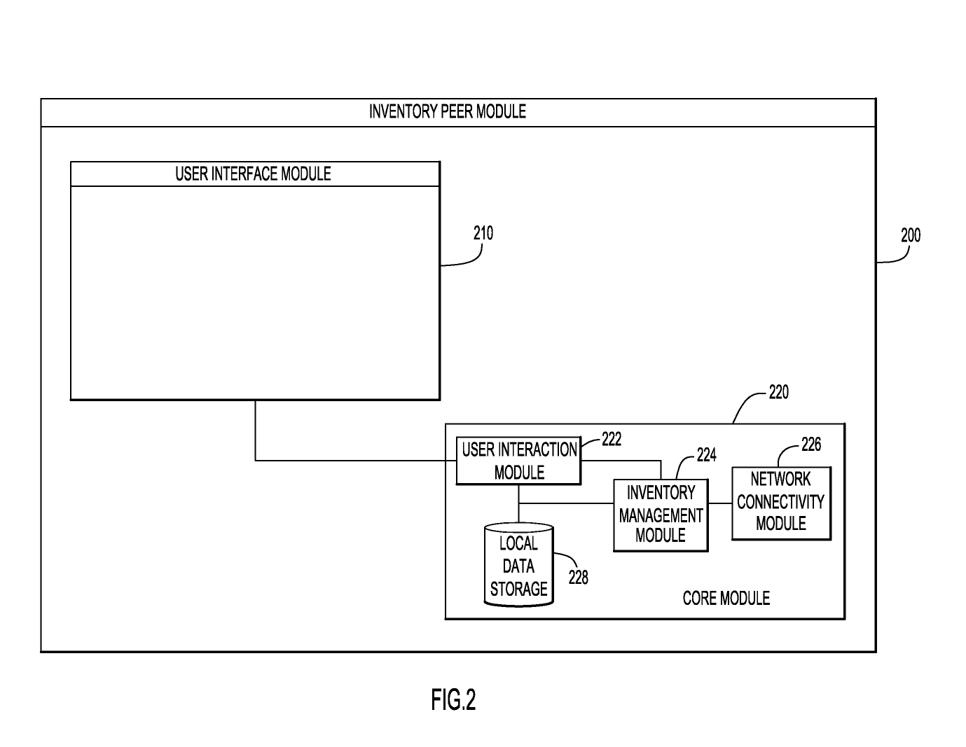

Referring to FIG. 2, an inventory peer node 132 includes an inventory peer module 200 including a user interface module 210 and a core module 220 handling the storage of inventory information and publishing that information to consumers. The user interface may be tailored or customized based on the market segment, deployment partners, and other factors. Preferably, the user interface is customized to match the target field of business of the inventory provider, thereby providing a look, feel and flow of familiar market segment specific interfaces to enable quick and easy entry and arrangement of the inventory information as described below. The core module operates based on the date entered by the inventory provider on the user interface, and automatically handles the connectivity to the peer-to-peer network and communication with consumer inventory modules on various network access devices, thereby allowing the inventory to be accessed without requiring each inventory provider to do anything more than load the inventory peer module and define their inventory. In addition, an install module handles installation of the inventory peer module and authentication of the inventory provider as described below.

The inventory peer module may be distributed via mass marketing campaigns over electronic mail (e-mail), social networks, or paper mail campaigns and directly to the individual inventory providers. Alternatively, the inventory peer module may be distributed via formal associations, such as retailer organizations, hotelier organizations (e.g., bed and breakfast associations) or other industry specific or focused associations of entities. The inventory peer module may utilize an Internet installer or install module 197 allowing for simple installation and automated update of the module over the Internet from download system 195 (e.g., requiring no intervention from the user when updates are released). The install module may include any conventional or other type of software code installer.

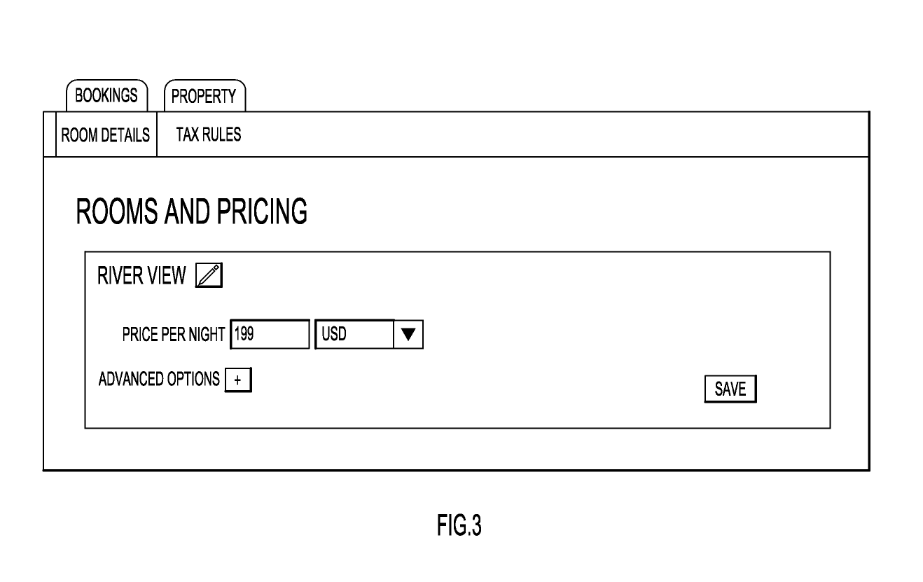

Although core module 220 remains virtually unchanged between platforms and markets, the user interface provided by user interface module 210 is customized depending on the target user base and platform to be used by the user base. For example, in a scenario where the inventory provider is a small Bed and Breakfast property operator, the user interface provided is of a simple operation, and only a few configuration options are needed. An example user interface for this type of operation is illustrated in FIG. 3. In this case, the user interface enables the inventory provider to simply specify the geographical location, number of rooms, price per occupant, date of occupancy, and a few other simple parameters. The user interface enables the entered property information to become immediately available for access by potential guests.

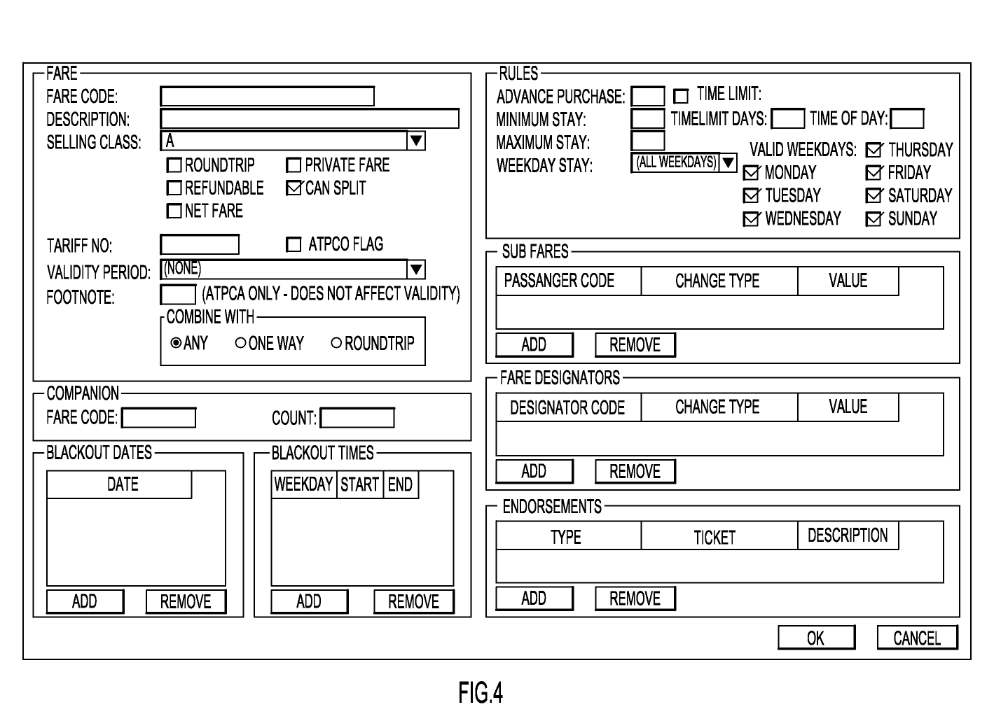

With respect to more complex inventory operations (e.g., airlines, large resorts, etc.), user interface module 210 provides a user interface with advanced inventory definition options (e.g., weekday availability, advance purchase restrictions, overbooking option, etc.). Thus, inventory pricing may be defined with highly advanced pricing features (e.g., advance purchase, seasonality, discounts, promotion codes, inventory level pricing, pricing available for specified time periods, etc.). An example of this type of user interface is illustrated in FIG. 4.

Referring back to FIG. 2, once the inventory information is published via user interface module 210, core module 220 connects a corresponding inventory peer node 132 (FIG. 1) to the peer-to-peer network, and makes the inventory information available for searching and access to any participant in that network. The core module further accepts requests from participants in the peer-to-peer network for the published inventory, processes the requests (e.g., searches and retrieves requested information), and returns the requested information. The core module includes a user interaction module 222, an inventory management module 224, a network connectivity module 226, and a storage unit 228. The user interaction module interacts with the inventory provider via the user interface, and performs the desired functions entered by the inventory provider. The inventory management module manages the inventory information (e.g., retrieving and storing information in the data storage unit, processing search requests from network participants, etc.), while network connectivity module 226 provides communication with the peer-to-peer network. The network connectivity module may further provide communications between a consumer, inventory provider, and/or an intermediary via any conventional or other techniques (e.g. electronic mail, chat, Voice Over IP (VOIP), whiteboard, etc.) before, during and/or after a transaction for the inventory. The data storage unit stores the inventory information (e.g., information pertaining to the inventory, transactions for the inventory, bookings, reservations, payments, cancellations, etc.), and may be implemented by any conventional or other storage structure (e.g., database, file system, data structure, etc.).

The peer-to-peer approach enables automated propagation of a newly installed inventory peer node using standard peer-to-peer functionality of super nodes 160 (FIG. 1). The super nodes maintain the various nodes and elements of the peer-to-peer network, and include general peer-to-peer functionality that enables individual inventory peer nodes 132 to publish the details about the corresponding type and availability of the inventory. Super nodes 160 further manage the transmission and brokering of messages between nodes, and ensure that restrictions by a firewall 135 (FIG. 1) do not prevent participants in the peer-to-peer network from communicating with one another. For example, a computing device node 114 of a consumer 110 desires to communicate with an inventory peer node 132 containing certain inventory information. If the inventory peer node is not restricted by a firewall 135, computing device node 114 may directly access that inventory peer node via peer-to-peer communication. However, when the inventory peer node is protected by a firewall 135, direct access by computing device node 114 via peer-to-peer communication is not allowed. In this case, computing device node 114 accesses the restricted inventory peer node 132 via a super node 160. This ability to obviate firewall restrictions is one of the strengths of a peer-to-peer architecture, since this removes the burden of having the users be familiar with the administrative tasks typically required in order to enable networked nodes to communicate with one another from behind firewall protections over the public Internet.

Super nodes 160 further serve to authenticate participants of the peer-to-peer network, thereby only allowing participants with valid credentials to have access to the resources of the other participants in the network. Encrypted communication between the individual nodes via network 140 ensures that the exchanged information is not intercepted and abused. The super nodes replicate and distribute data from each inventory peer node among multiple super nodes. This allows for workload distribution, geographic grouping of super and/or inventory peer nodes, and automatic recovery in cases where super nodes, or entire portions of the peer-to-peer network are unable to accept or respond to messages. Super nodes 160 are geographically distributed to enable messaging between network nodes to be routed via the super nodes, thereby optimizing the flow of network traffic across geographically separated nodes, and allowing nodes near one another to communicate via the super nodes in relative geographic proximity.

Peer-to-peer network 100 may include direct access nodes 162 that simply access the inventory information published by inventory peer nodes 132 (without publishing inventory information). The direct access nodes directly participate in the peer-to-peer network by communicating with other peer nodes in the network. Direct access nodes 162 may include mobile and computing device nodes 112, 114 that enable corresponding consumers 110 to access the network. As described above, communication between direct access nodes 162 and inventory peer nodes 132 is conducted either directly when firewall restrictions allow direct communication, or via super nodes 160 when firewall restrictions do not allow direct connectivity to an inventory peer node 132 via the public Internet. The direct access nodes may include personal or other computer systems, laptops, mobile devices, mobile phones, and other computing devices with one or more of the inventory modules (e.g., core module 220) to connect to the peer-to-peer network and search the published inventory information.

Access may be provided to users or consumers that are not directly connected to the peer-to-peer network. For example, users or consumers may use devices and/or platforms that are unable to receive the inventory modules. In these cases, the users may gain access to the published inventory via a web browser on a mobile or computing device node 112, 114 using web site 117 hosted on server system 116 (FIG. 1) as described above. The server system acts as a direct access peer node into the peer-to-peer network, thereby providing the inventory information in a web browser accessible format. In this case, the server system acts as a “proxy” for the consumer and performs the necessary peer-to-peer transactions to search, check and capture desired inventory information on an inventory peer node 132.

Moreover, the peer-to-peer network may be accessed from existing or legacy inventory and services distribution channels and organizations (e.g., online travel sites, global distribution systems, etc.). These systems already provide access for consumers and agents (e.g., via agent systems 118) to the inventory of large inventory providers (e.g., airlines, hotels, car rental agencies, etc). However, these systems lack direct access to the inventory of smaller inventory providers. Access gateway 122 bridges connectivity between legacy distribution channels 120 (e.g., the inventory and services distribution systems) and the peer-to-peer network. The legacy distribution channels may provide the ability for smaller inventory providers to offer their inventory to the consumers of the legacy channels. Since the legacy channels typically incur transaction fees when used to complete inventory sales, the original inventory provider needs to control the cost of distribution of their inventory as these legacy channels may be prohibitively costly for some smaller operations. Agent systems 118, distribution channels 120, and access gateway 122 may be implemented by any conventional or other computer or processing systems or devices preferably equipped with a display or monitor, a base (e.g., including the processor, memories and/or internal or external communications devices (e.g., modem, network cards, etc.)), optional input devices (e.g., a keyboard, mouse or other input device), and any commercially available and/or custom software (e.g., server/communications software, one or more inventory modules, browser/interface software, etc.).

In addition, the peer-to-peer network may further include participants that provide value added services to inventory providers and other network participants as described above. These services include: payment processing (e.g., payment processing system 170), online backup and restore (e.g., backup system 190), inventory hosting (e.g., hosted inventory system 180), download and authentication (e.g., authentication system 195), and various advertising or other services (not shown)). These systems interact with install module 197 and/or core module 220 (FIG. 2) of an inventory peer node 132 when an inventory provider 130 downloads modules or registers for those services via the user interface. As new services are added to the peer-to-peer network, updates to the user interface are automatically released to allow inventory providers to select and pay for those services.

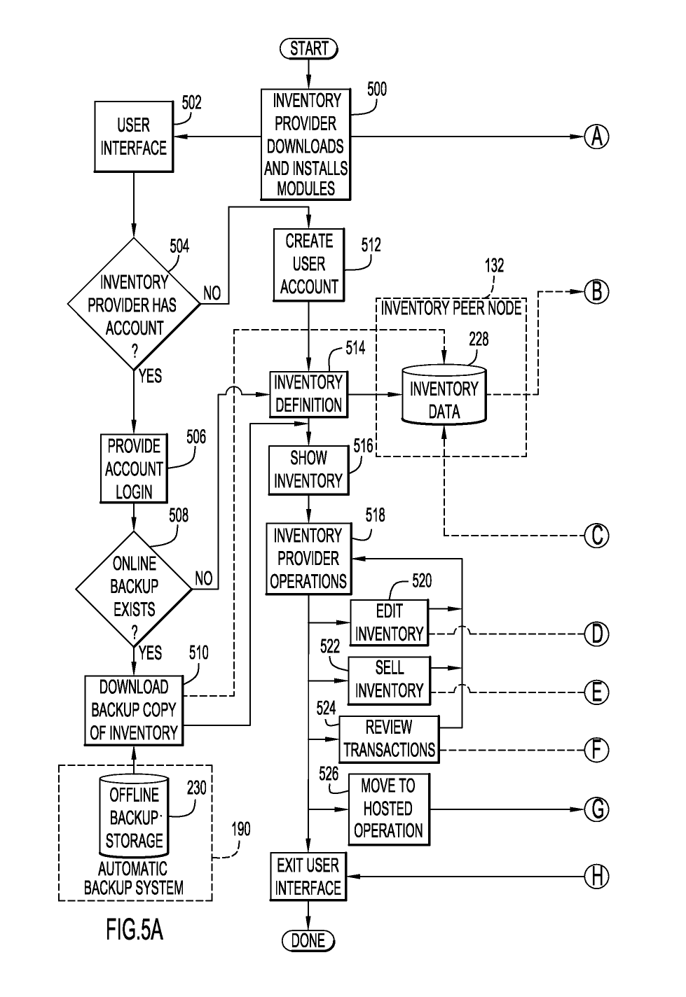

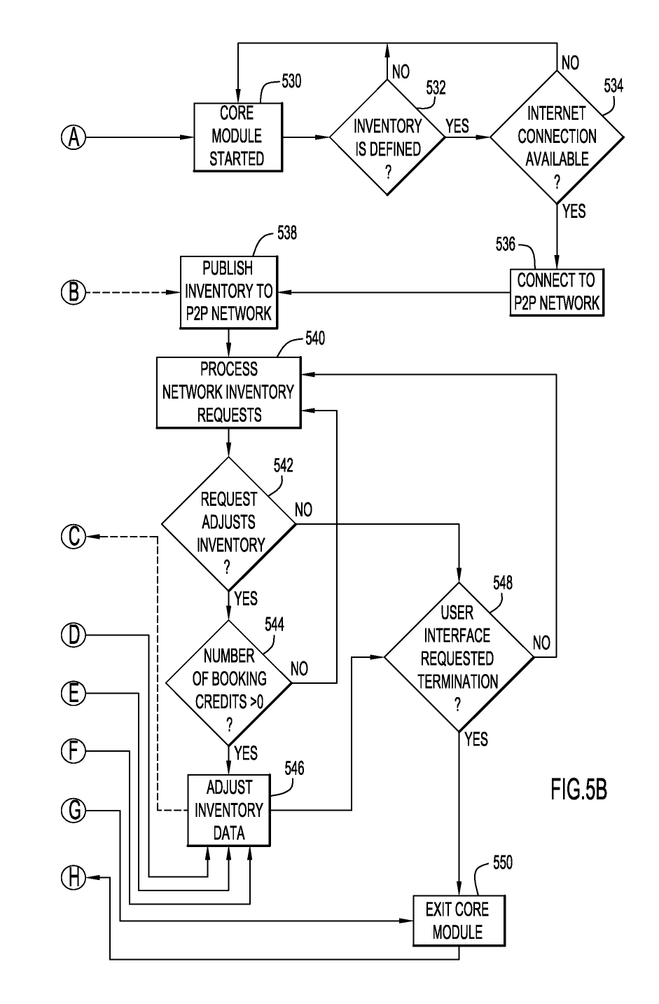

The manner in which an inventory provider defines inventory for publication (e.g., via an inventory peer node 132 and inventory peer module 200) on the peer-to-peer network according to an embodiment of the present invention is illustrated in FIGS. 5A-5B. Initially, an inventory provider 130 downloads and installs inventory peer module 200 on a corresponding inventory peer node 132 at step 500. For example, the install module and inventory peer module may be downloaded from download system 195, where the inventory peer module is installed via install module 197. A specific segment of inventory providers or network participants may have access to additional features, services or capabilities due to their association with a deployment partner (e.g., trade association, tourism authorities, merchant organizations, etc.). In this case, the module deployment requires authentication at the time of the module download and prior to installation, and active confirmation of the authentication during installation of the inventory peer module by authentication system 195 or an online data source (e.g., online web service, peer node, etc). The additional features for inventory providers associated with the deployment partner include pre-populating information about the inventory provider and/or inventory from a database 187 of deployment partner system 185. This information can be a business name, address, type of inventory, pricing information, geographical information, inventory attributes (e.g., hotel amenities, etc.), etc.

Once the inventory provider enters information (e.g., passcode, PIN, user identification, module identification, etc.) prior to installation indicating the inventory provider is an associate of a deployment partner, the entered information is used (e.g., by the install module) to authenticate the inventory owner via authentication system 195 and retrieve corresponding information from deployment partner system 185 via online transactions. This allows the inventory provider to avoid entering information that has already been registered with their association. The install module further utilizes the online transactions to periodically retrieve the information from deployment partner system 185, and update the inventory peer module information to prevent the inventory provider from updating their information in two places.

The active confirmation during the installation and initial configuration of the inventory peer module requires that the inventory provider supply information provided by the deployment partner. This information (e.g., passcode, PIN, user identification, module identification, etc.) is used by install module 197 in an online transaction against authentication system 195 that accesses database 187 of deployment partner system 185, thereby confirming or invalidating the information provided by the inventory provider claiming to be associated with the deployment partner. Once the deployment partner association is validated, the install module continues the installation process to install the inventory peer module on the corresponding inventory peer node.

Once the inventory peer module is installed, the user interface (preferably tailored to the inventory provider) is presented at step 502 (e.g., FIG. 3 or 4), and the presence of a user account for the inventory provider is determined at step 504. A user may alternatively opt for totally offline operation with no sales capability. If a user account does not exist for the inventory provider, an account is created at step 512, and the inventory is defined via the user interface at step 514 and stored in a storage unit 228 of the inventory peer node. Alternatively, the inventory may be defined in whole or in part via information from deployment partner system 185 as described above.

When the inventory provider has a user account as determined at step 504, the user interface provides an account login at step 506. If an online backup of the inventory information exists as determined at step 508, the inventory information is downloaded from an offline backup storage unit 230 of backup system 190 at step 510. When a backup does not exist, the inventory is defined via the user interface (or deployment partner system 185) at step 514.

Once the inventory is defined or downloaded, the inventory is displayed on the user interface at step 516, and the user interface enables the inventory provider to perform various operations at step 518 (e.g., via the user interaction module 222 and inventory management module 224 of core module 220). For example, the user interface enables the inventory provider to edit the inventory at step 520, sell inventory at step 522, review a transaction at step 524, and move the inventory to a host system (e.g., hosted inventory system 180) at step 526. In addition, inventory providers may limit access to all or specific parts of or data relating to the inventory to specific systems, nodes, consumers, or other groups. For example, certain association members may access tariffs specifically applicable to them, and certain distribution channels may be included or excluded from all or parts of the inventory offering according to static or dynamic criteria.

With respect to the core module, the core module is started at step 530 and waits for an indication that the inventory has been defined at step 532. The core module (e.g., via network connectivity module 226) determines the availability of an Internet connection at step 534, and connects to the peer-to-peer network at step 536 via an available connection. The inventory is retrieved from storage unit 228 and published to the peer-to-peer network at step 538 (e.g., via inventory management module 224). This is accomplished by informing super nodes 160 about the inventory information to enable requests for the inventory information to be directed to the inventory peer node.

The core module processes requests for inventory received from other nodes within the peer-to-peer network at step 540. If the request adjusts the inventory (e.g., a purchase that reduces the available inventory) as determined at step 542 and the inventory provider possesses sufficient credits for the request (described below) at step 544, the inventory is adjusted at step 546. The inventory may further be adjusted based on the inventory provider operations at steps 520 (edit), 522 (sell), and 524 (review transaction).

The core module continues to process inventory requests until the inventory provider requests termination of the user interface at step 548. Once this occurs, the core module is terminated at step 550.

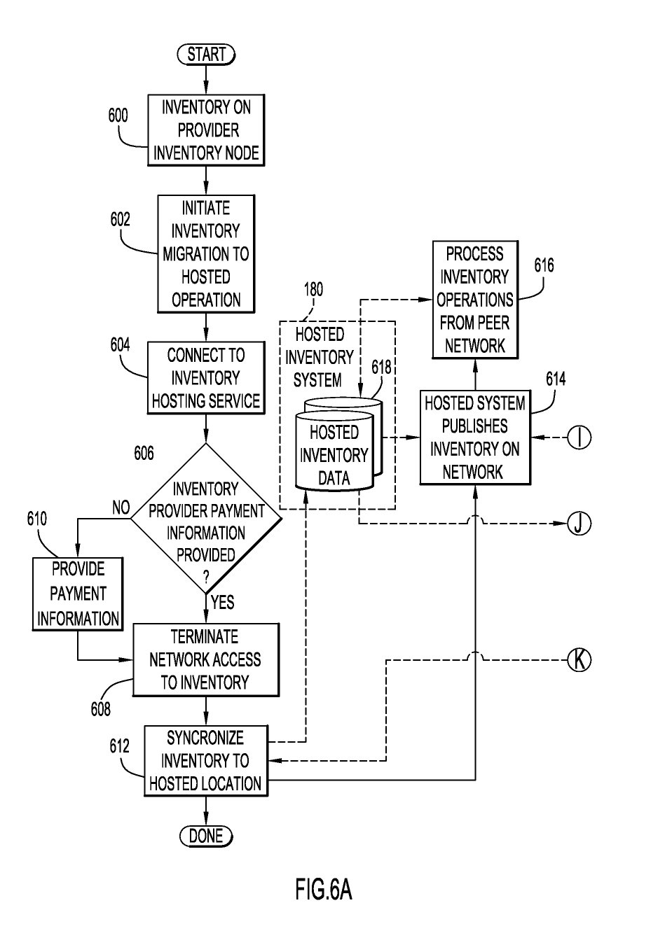

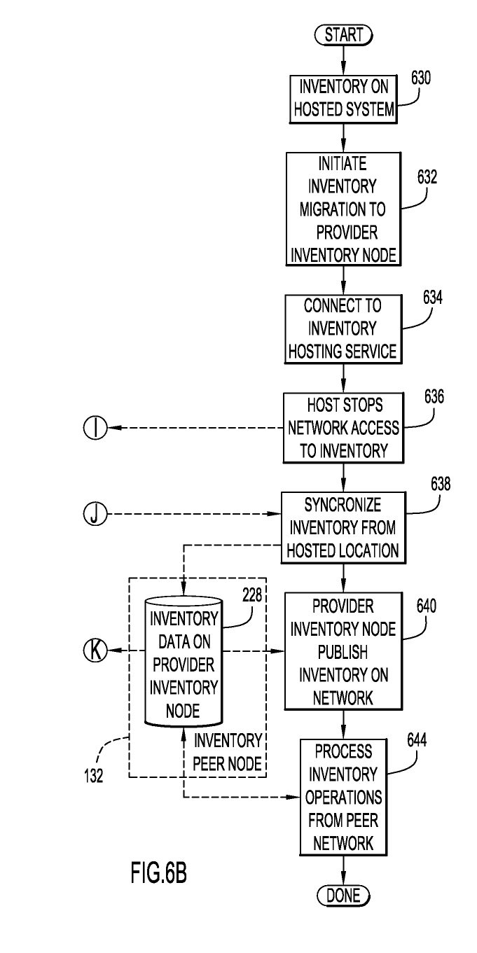

The inventory of an inventory provider may be accessible from an individual installation at a hosted service, thereby allowing the inventory to be shown as available for purchase or allocation (even when an inventory peer node is not active and part of the peer-to-peer network). An inventory provider determines when to move the inventory to the hosted location and back to the inventory peer node. This ensures that no duplicate activity takes place on the same inventory. The manner in which the inventory is migrated between a hosted location and an inventory peer node (e.g., via hosted inventory system 180 and an inventory peer node and corresponding inventory peer module) according to an embodiment of the present invention is illustrated in FIGS. 6A-6B. Initially, the inventory (e.g., inventory information (e.g., information pertaining to the inventory, transactions for the inventory, bookings, reservations, payments, cancellations, etc.)) resides on an inventory peer node 132 at step 600, and the inventory migration is initiated (e.g., via the user interface of the inventory peer node) to hosted inventory system 180 at step 602. A connection is established to hosted inventory system 180 at step 604 (e.g., via the core module), and if the inventory provider has not provided payment information as determined at step 606, the payment information is provided at step 608 (e.g., via the user interface of the inventory peer node). Access to the inventory information (e.g., information pertaining to the inventory, transactions for the inventory, bookings, reservations, payments, cancellations, etc.) from the peer-to-peer network is terminated at step 610 (e.g., via the core module), and the inventory information is synchronized to storage units 618 of hosted inventory system 180 at step 612. The access termination may be accomplished by informing super nodes 160 of the termination to prevent requests for inventory information to be directed to the inventory peer node. Hosted inventory system 180 publishes the inventory on the peer-to-peer network at step 614, and processes inventory requests from the network at step 616. The publication of the inventory is accomplished by the hosted inventory system informing super nodes 160 of the availability and location of the inventory (e.g., on the hosted inventory system) to enable requests for inventory information to be directed to the hosted inventory system.

With respect to migration of the inventory information (e.g., information pertaining to the inventory, transactions for the inventory, bookings, reservations, payments, cancellations, etc.) to the inventory peer node, the inventory information initially resides on hosted inventory system 180 at step 630, and the migration is initiated to the inventory peer node at step 632. A connection is established by the inventory peer node to hosted inventory system 180 at step 634 (e.g., via the core module), and the hosted inventory system terminates access to the inventory from the peer-to-peer network at step 636 (e.g., via an inventory module). The access termination may be accomplished by informing super nodes 160 of the termination to prevent requests for the inventory information to be directed to the hosted inventory system. The inventory information (e.g., information pertaining to the inventory, transactions for the inventory, bookings, reservations, payments, cancellations, etc.) on the hosted inventory system is synchronized with the inventory information in storage unit 228 of the inventory peer node at step 638 (e.g., via inventory management module 224). The inventory peer node publishes the inventory on the peer-to-peer network at step 640 (e.g., via inventory management module 224), and processes inventory requests from the network at step 644. The publication of the inventory is accomplished by the inventory peer node informing super nodes 160 of the availability and location of the inventory (e.g., on the inventory peer node) to enable requests for the inventory information to be directed to the inventory peer node.

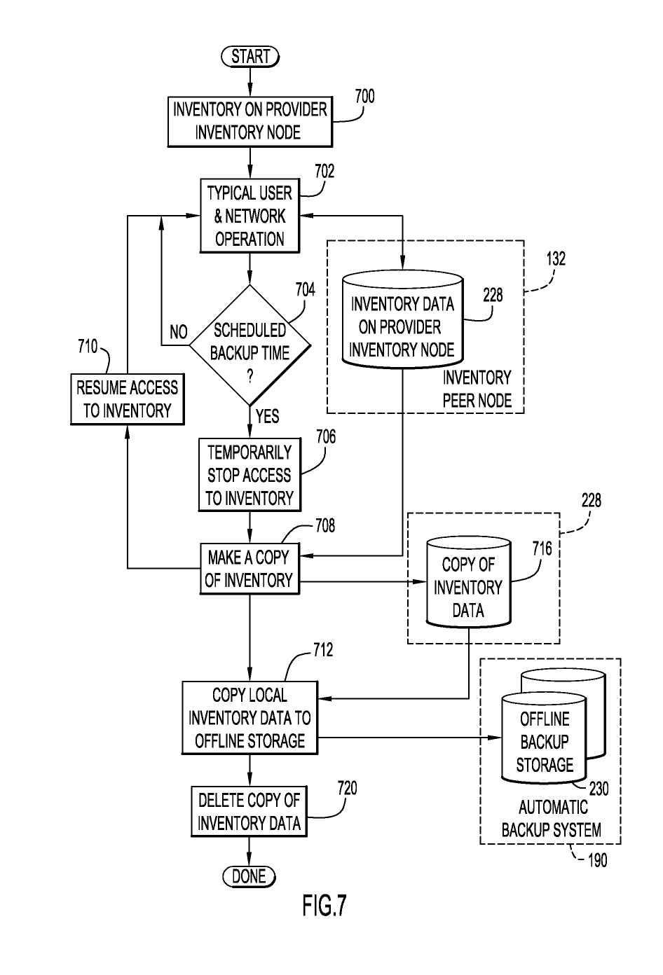

In order to protect against total data loss, the peer-to-peer infrastructure provides automatic creation of backups of the individual inventory provider's inventory (e.g., information pertaining to the inventory, transactions for the inventory, bookings, reservations, payments, cancellations, etc.) and data related to the inventory peer module. The backup operation periodically copies the inventory information and data over the Internet to be stored on a hosted backup service (e.g., backup system 190). The manner in which the inventory and data are backed-up (e.g., via the inventory peer node and corresponding inventory peer module) according to an embodiment of the present invention is illustrated in FIG. 7. Initially, the inventory information (e.g., information pertaining to the inventory, transactions for the inventory, bookings, reservations, payments, cancellations, etc.) resides on an inventory peer node 132 at step 700, and the node performs various operations (e.g., adjusts inventory, processes requests from the network, etc.) at step 702. These operations are performed until the scheduled backup time arrives as determined at step 704. Once the scheduled backup time arrives, the inventory peer node temporarily terminates access to the inventory from the peer-to-peer network at step 706, and generates a copy of the inventory information (e.g., information pertaining to the inventory, transactions for the inventory, bookings, reservations, payments, cancellations, etc.) from storage unit 228 (e.g., via inventory management module 224) for storage in a copy storage area 716 of storage unit 228 of the inventory peer node at step 708. The access termination may be accomplished by informing super nodes 160 of the termination to prevent requests for the inventory information to be directed to the inventory peer node.

Access to the inventory from the peer-to-peer network is restored at step 710, and the local inventory is copied to offline backup storage 230 of backup system 190 at step 720. The access restoration may be accomplished by informing super nodes 160 to enable requests for the inventory information to be directed to the inventory peer node. Once the inventory information is copied, the generated copy is deleted at step 720.

The restoration of data is typically performed as part of the installation when the inventory provider account is recognized as an existing account. The restoration of the inventory is described above in relation to FIGS. 5A-5B (e.g., steps 508 and 510).

When an individual inventory provider places the inventory peer module on the inventory peer node and defines the inventory as described above, the inventory peer node immediately becomes part of the peer-to-peer network. However, in order for consumers to be able to access and purchase or reserve the inventory via the peer-to-peer network, the inventory provider purchases credits that enable transactions with the consumer to occur. Each purchased credit allows for a defined number of inventory purchase transactions to occur, and typically each purchased credit will enable a single purchase transaction.

Once all purchased credits are exhausted, the inventory peer node is no longer accessible via the peer-to-peer network. However, the inventory provider may still use the inventory peer module and manage (e.g., via the user interface) the inventory manually. Unless the inventory provider account shows available credits, this inventory is not available for online lookup and purchase. Alternatively, the accesses may be permitted without requiring the inventory provider to purchase and/or possess credits.

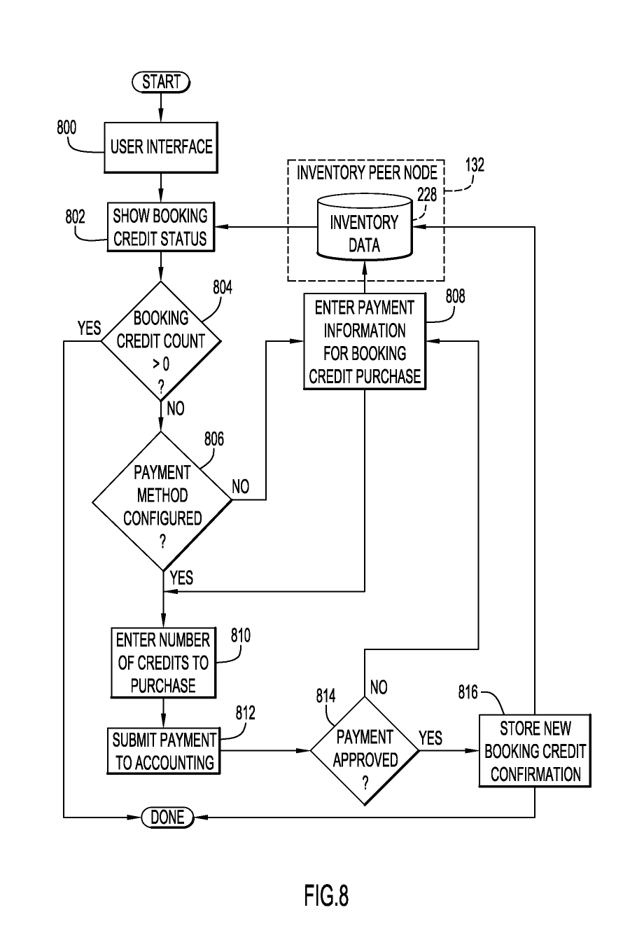

The manner in which credits are purchased (e.g., via the inventory peer node and corresponding inventory peer module) according to an embodiment of the present invention is illustrated in FIG. 8. Initially, the user interface of the inventory peer node is initiated (e.g., via user interface module 210) at step 800, and the booking credit status is displayed at step 802. The booking credits are typically maintained within storage unit 228 of the inventory peer node.

If the inventory provider has exhausted the credits as determined at step 804, the inventory peer node determines if payment information has been received at step 806. When payment information has not been received, the payment information is entered at step 808. The inventory provider enters the desired quantity of credits to purchase at step 810, and payment is submitted to payment processing system 170 for processing at step 812. If the payment is not accepted as determined at step 814, payment information is entered at step 808 as described above. When payment is accepted, the booking credit information is stored in storage unit 228 at step 816, and users or consumers may access the inventory information over the peer-to-peer network.

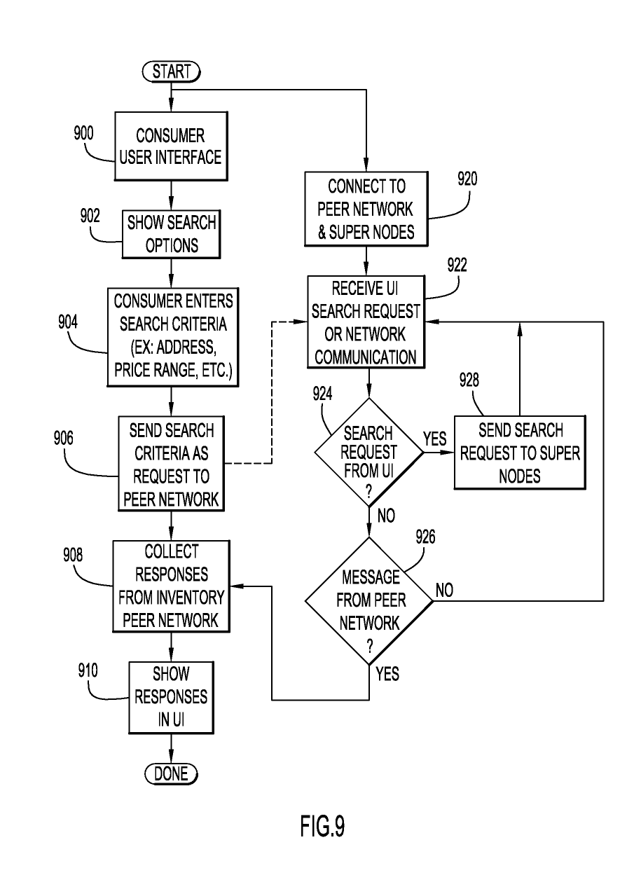

Once an inventory provider has loaded the inventory peer module on an inventory peer node and defined the inventory desired for publication to potential consumers (e.g., within or external of the peer-to-peer network), those consumers may access the inventory via the peer-to-peer network. The manner in which the inventory is accessed on the peer-to-peer network (e.g., via a direct access device and one or more inventory modules) according to an embodiment of the present invention is illustrated in FIG. 9. Initially, the manner of accessing inventory is described, by way of example, with respect to a consumer accessing the peer-to-peer network via a direct access node 162 (e.g., mobile or computing device node 112, 114 with one or more inventory modules). In particular, a user interface is initiated on the direct access node at step 900, and search options are presented on the user interface at step 902. The consumer may enter various search criteria (e.g., address, price range, etc.) on the user interface to search for desired inventory on the peer-to-peer network at step 904. Alternatively, these criteria may be generated automatically or semi-automatically by another system directly or indirectly linked to the consumer.

The search criteria are submitted as a request to the peer-to-peer network at step 906. Super nodes 160 direct the request to appropriate inventory peer nodes, and responses to the request are received from the peer-to-peer network at step 908. The responses are displayed on the user interface at step 910, preferably in the form of a list of inventory peer nodes responding to the request.

The direct access node connects to the peer-to-peer network and super nodes 160 at step 920. The direct access node receives a generated search request from the user interface or a communication from the peer-to-peer network at step 922. If a search request is received from the user interface (e.g., step 906) as determined at step 924, the search request is sent to super nodes 160 at step 928. The super nodes replicate and distribute data from each inventory node among multiple super nodes, and provide for routing of messages as described above. This enables the super nodes to determine the appropriate inventory peer nodes of the peer-to-peer network having desired information for search requests, and to direct the search requests to those nodes. Responses to the search requests from the appropriate inventory peer nodes are returned to the requesting node via the peer-to-peer network.

If a communication is received (e.g., responses to the search request) as determined at step 926, the message is provided for collection and display on the user interface as described above (e.g., steps 908 and 910). Alternatively, the results or communication may be passed in the form of a message or response to be communicated to a third party or other system.

The manner in which the inventory is accessed on the peer-to-peer network via server system 116 (FIG. 1) and hosted web site 117 is substantially similar to the manner described above for a direct access device. In this type of embodiment, the consumer web browser performs the functions of the user interface described above, and connects to server system 116. The server system participates in the peer-to-peer network as a peer-to-peer node and performs the communication and other functions of the direct access node described above.

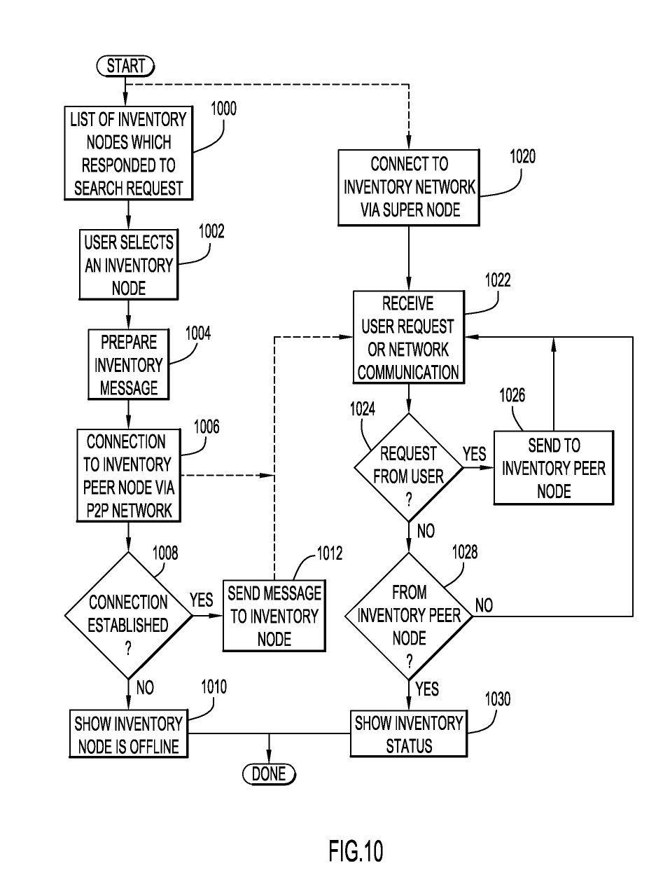

Once the consumer has received a list of inventory peer nodes containing inventory information that satisfies the consumer search criteria, the consumer may select an inventory peer node and access the inventory published by that node. The manner in which a consumer accesses inventory published by a selected inventory peer node on the peer-to-peer network according to an embodiment of the present invention is illustrated in FIG. 10. Initially, a direct access node 162 (e.g., mobile and computing device nodes 112, 114) and/or an indirect access node (e.g., server system 116) may submit search requests to the peer-to-peer network and receive responses to those requests as described above. A list of inventory peer nodes that responded to the search request are displayed on the user interface (or web browser) of the direct and/or indirect access nodes at step 1000. The consumer selects an inventory peer node from the displayed list at step 1002, and an inventory message for the selected inventory peer node is prepared at step 1004.

A connection over the peer-to-peer network to the selected inventory peer node is initiated at step 1006. Once the connection is established as determined at step 1008, the inventory message is transmitted over the peer-to-peer network to the selected inventory node at step 1012. This may be accomplished by a direct transmission in the case where the selected inventory peer node is not protected by a firewall, or via a super node 160 when the selected inventory peer node is protected by a firewall as described above. If the connection cannot be established as determined at step 1008, a message is provided indicating that the selected inventory peer node is offline at step 1010, and the process terminates.

The direct or indirect access node initially connects to the peer-to-peer network via a super node 160 at step 1020. The node receives a user request from the user interface (e.g., step 1012) or a communication from the peer-to-peer network at step 1022. If a user request or inventory message is received (e.g., step 1012) as determined at step 1024, the inventory message is sent to the selected inventory peer node at step 1026. This may be accomplished by a direct transmission in the case where the selected inventory peer node is not protected by a firewall, or via a super node 160 when the selected inventory peer node is protected by a firewall as described above. The inventory peer node receives and processes the inventory message, and returns the desired information to the requesting direct or indirect access node over the peer-to-peer network. In cases where the inventory is being hosted on hosted inventory system 180, the peer to peer connection will be confirmed, and the hosted inventory system will respond to the inventory message.

If a communication is received (e.g., responses to the inventory message from the selected inventory peer node) as determined at step 1028, the requested inventory of the selected inventory peer node is displayed at step 1030. This information is provided within the desired information transmitted from the selected inventory peer node and generated from processing of the inventory message. Since requesting nodes communicate with the inventory peer nodes containing the desired information, the displayed inventory of the selected inventory peer node is up to date and current. Thus, a requesting node may have immediate access to inventory information published by an inventory provider, and may receive the most current inventory information despite rapid changes to the inventory within the peer-to-peer network due to various operations. In other words, the peer-to-peer infrastructure provides consumers with “live” inventory information that may fluctuate rapidly due to inventory operations.

Consumers may further use legacy channels to access the inventory published by inventory providers on the peer-to-peer network. In this case, the consumers access the inventory by interfacing with access gateway 122 (FIG. 1) via agent systems 118 and legacy distribution channels 120. Access gateway 122 translates lookup requests from agent systems 118 and/or legacy distribution channels 120 into messages that communicate with the inventory peer nodes in the peer-to-peer network. Responses from inventory peer nodes in the network are processed by access gateway 122 and translated into responses which the legacy system can interpret and merge together with its own results for final presentation to the agent or consumer.

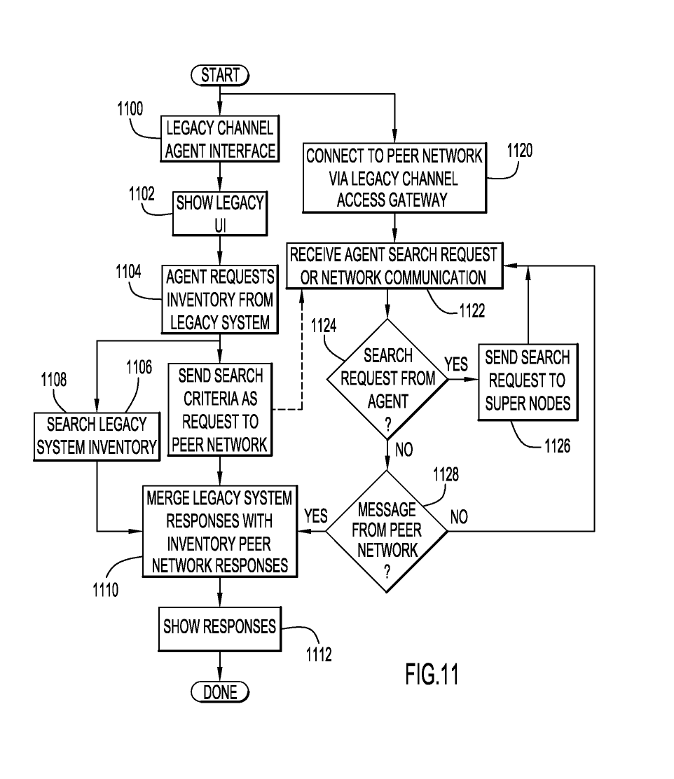

One of the manners in which the legacy channels are utilized to access the published inventory of the peer-to-peer network (e.g., via agent systems 118, legacy distribution channels 120, and access gateway 122) according to an embodiment of the present invention is illustrated in FIG. 11. Initially, an agent system 118 provides a legacy channel user interface at step 1100, and displays this interface at step 1102. The agent system further requests inventory from a legacy system of legacy distribution channels 122 at step 1104. The legacy system is searched at step 1108 to provide the requested inventory information. Moreover, agent system 118 sends requests including search criteria to the peer-to-peer network at step 1106 to retrieve published inventory information.

A connection to the peer-to-peer network is initially established via access gateway 122 at step 1120. The agent system receives a search request from the legacy user interface (e.g., step 1106) or a communication from the peer-to-peer network (e.g., via access gateway 122) at step 1122. If a search request is received from the legacy user interface (e.g., step 1106) as determined at step 1124, the search request is sent to super nodes 160 at step 1126. The super nodes replicate and distribute data from each inventory node among multiple super nodes, and provide for routing of messages as described above. This enables the super nodes to determine the appropriate inventory peer nodes of the peer-to-peer network having desired information for search requests, and to direct the search requests to those nodes. Responses to the search requests from the appropriate inventory peer nodes are returned to the requesting node via the peer-to-peer network.

If a communication is received (e.g., responses to the search request) as determined at step 1128, the search results from the peer-to-peer network (e.g., list of responding inventory peer nodes) within received communications are merged with the results from the legacy system at step 1110. The merged information is displayed on the agent system at step 1112. An inventory peer node may be selected to access information published by that node in substantially the same manner discussed above (e.g., FIG. 10).

In addition, consumers may access the legacy channels via direct and/or indirect (e.g., server system 116 and website 117) access nodes of the peer-to-peer network to access the inventory maintained by those legacy channels. In this case, the peer-to-peer network directs requests for inventory from the direct and/or indirect access nodes to access gateway 122 (FIG. 1). Access gateway 122 translates these requests into messages for the legacy channels to retrieve desired inventory information from those legacy channels. Responses from the legacy channels are processed by access gateway 122 and translated into responses that are sent over the peer-to-peer network to the requesting direct and/or indirect access nodes. Transactions for the inventory of the legacy channels may be conducted via processing of the transactions by the access gateway. Thus, the access gateway, in effect, enables the legacy channels to function as a peer node and to publish and conduct transactions for inventory on the peer-to-peer network.

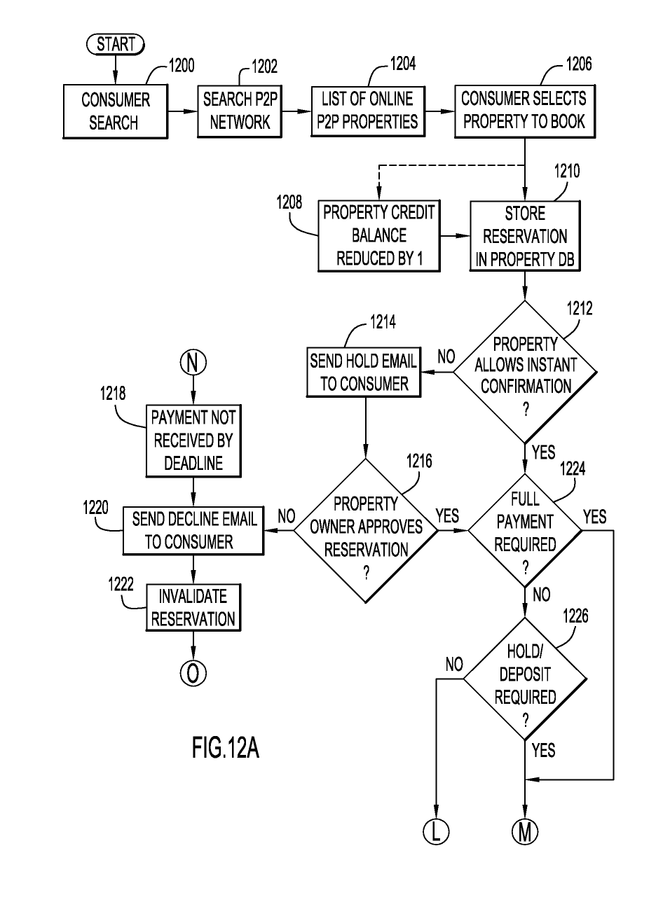

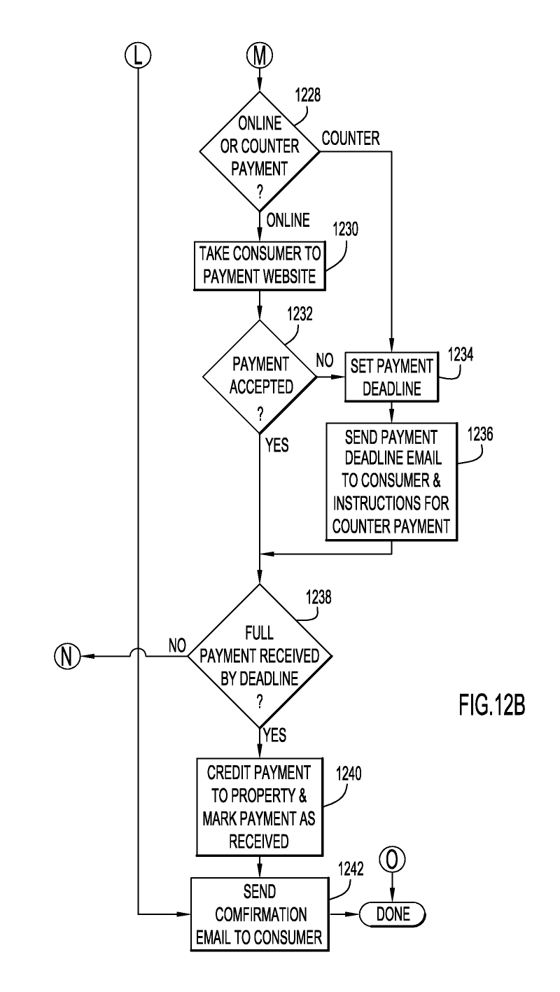

Once published inventory has been retrieved from the peer-to-peer network and displayed on a direct and/or indirect access node, a consumer may purchase or perform other transactions on the published inventory of the peer-to-peer network. An example manner of purchasing inventory according to an embodiment of the present invention is illustrated in FIGS. 12A-12B. Initially, the example pertains to inventory in the form of property and making a reservation for that property (e.g., making a reservation at a hotel, bed and breakfast, etc.). However, the manner described below may be performed in substantially the same manner for any type of inventory to conduct a transaction. Specifically, a consumer provides search criteria on a direct access node 162 (e.g., mobile and computing device nodes 112, 114) and/or an indirect access node (e.g., server system 116 and corresponding hosted web site 117, agent system 118, a legacy system, etc.) at step 1200. The direct and indirect access nodes each include one or more inventory modules that enable these nodes to conduct the transactions and perform the functions described below. The search request is processed by the peer-to-peer network at step 1202 as described above and, after selection of one or more responding inventory peer nodes, a list of relevant properties are displayed to the consumer at step 1204. The direct or indirect access node may indicate the geographic location of the listed properties via a conventional or other mapping system (e.g., GOOGLE maps, etc.). In this case, the consumer may receive textual or other location information (e.g., addresses, indications of the location on a geographic map, etc.).

The consumer selects a desired property from the displayed list at step 1206, and the credits enabling consumer transactions for the property provider within the peer-to-peer network (e.g., FIG. 8) are reduced due to the transaction at step 1208. The reservation is stored within a storage unit 228 of the inventory peer node hosting the selected property. If an instant confirmation is not permitted (e.g., in other words, confirmation by the property provider is needed) as determined at step 1212, an electronic mail (e-mail) message is transmitted to the consumer at step 1214 indicating the property is being reserved. Alternatively, the property provider may provide a price quote to the consumer that is valid for a predetermined time interval. The price quote may be provided via the electronic mail (e-mail) message or other communication techniques (e.g., chat, Voice Over IP (VOIP), whiteboard, etc.). In order to accept the price quote, the consumer needs to reply within the predetermined time interval.

When the property provider does not approve of the reservation as determined at step 1216 (e.g., the property provider is not satisfied with the transaction, a reply to a price quote is not received within the predetermined time interval, etc.), or payment for the reservation has not been received by a certain deadline as determined at step 1218, an electronic mail (e-mail) message is transmitted to the consumer at step 1220 indicating the reservation has been canceled. In addition, the reservation is subsequently invalidated at step 1222.

If the reservation has been approved by the property provider (e.g., the property provider is satisfied with the transaction, a reply to a price quote has been received within the predetermined time interval, etc.) as determined at step 1216, or the reservation does not need this approval as determined at step 1212, payment for the reservation is determined. When no payment (e.g., full payment or a deposit) is needed for the reservation as determined at steps 1224 and 1226, a confirmation electronic mail (e-mail) message is transmitted to the consumer confirming the reservation at step 1242.

If a payment is required (e.g., either full payment or a deposit), the consumer may provide a payment online, or may manually provide the payment (e.g., over the counter at a retail establishment, ATM or other device, mailing of payment, etc.). When the consumer desires to pay online as determined at step 1228, the direct and/or indirect access node re-directs the consumer to a payment web site on payment processing system 170 (FIG. 1) to process the payment at step 1230. The consumer may provide credit card information, account information, login credentials and/or any other information to provide the payment. The payment processing system authenticates the information in order to perform the transaction.

When the online payment is not accepted as determined at step 1232, a deadline for the consumer to provide the payment manually is set at step 1234. The deadline is further set in response to the consumer desiring to provide the payment manually as determined at step 1228. The deadline may provide any suitable time interval (e.g., any quantity of days, weeks, months, etc.) for the consumer to provide the payment manually.

Once the deadline for providing payment is set, an electronic mail (e-mail) message is transmitted to the consumer at step 1236 indicating the deadline and instructions for providing the manual payment. Accordingly, the consumer manually provides the payment at a payment location or by mail (e.g., over the counter at a retail establishment, ATM or other device, mailing of payment, etc.) in accordance with the received instructions.

When full payment has been received by the deadline (e.g., either by manual payment or an online payment) as determined at step 1238, payment is indicated as being received and credited to the property provider at step 1240. In particular, payment processing system 170 transfers funds to an account for participants of the peer-to-peer network. In the case of an online payment, the funds are transferred from the consumer account to the peer-to-peer network account. With respect to a manual payment, funds are similarly transferred to the peer-to-peer network account, but the payment processing system may retain a portion of the funds as a fee for the entity providing the service or peer-to-peer network (e.g., another party involved in the payment process may similarly retain a fee on behalf of the entity). Payment processing system 170 credits the property with the funds, and retains a portion as a fee for the service or network provider. The funds collected for a property are distributed to the property provider (e.g., either manually or electronically) on a periodic (e.g., daily, weekly, monthly, etc.) or any other desired basis. The payment processing system transmits a message to the corresponding inventory peer node to indicate receipt of the payment. An electronic mail (e-mail) message is subsequently transmitted from that inventory peer node to the consumer confirming the reservation at step 1242.

The peer-to-peer network may provide communications between the consumer and one or more inventory providers via any conventional or other techniques (e.g. electronic mail, chat, Voice Over IP (VOIP), whiteboard, etc.) before, during and/or after the transaction. This enables the consumer to obtain additional information concerning the transaction (e.g., pricing, description of the inventory, payment options, shipping options, etc.).

It will be appreciated that the embodiments described above and illustrated in the drawings represent only a few of the many ways of implementing a method and system for inventory management over a peer-to-peer network.

The network topology of the present invention embodiments may include any quantity of any types of nodes (e.g., inventory peer nodes, mobile device nodes, computing device nodes, super nodes, server systems, gateways, legacy systems, agent systems, payment processing system, hosted inventory system, backup system, authentication system, deployment partner system, etc.) arranged in any fashion. The computing systems and devices (e.g., inventory peer nodes, mobile device nodes, computing device nodes, super nodes, server systems, gateways, legacy systems, agent systems, payment processing system, hosted inventory system, backup system, authentication system, deployment partner system, etc.) employed by the present invention embodiments may be implemented by any quantity of any personal or other type of computing or processing system or device (e.g., IBM-compatible, Apple, Macintosh, laptop, PDA, mobile telephone or other device, etc.), and may include any commercially available operating system (e.g., Windows, OS/2, Unix, Linux, etc.) and any commercially available or custom software (e.g., browser software, communications software, server software, install module and one or more other inventory modules, etc.). These systems may include any types of monitors and input devices (e.g., keyboard, mouse, voice recognition, etc.) to enter and/or view information.

It is to be understood that the software (e.g., inventory peer module, user interface module, core module, user interaction module, inventory management module, network connectivity module, install module and other modules for inventory management, etc.) for the computing systems or devices of the present invention embodiments (e.g., inventory peer nodes, mobile device nodes, computing device nodes, super nodes, server systems, gateways, legacy systems, agent systems, payment processing system, hosted inventory system, backup system, authentication system, deployment partner system, etc.) may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computing systems or devices (e.g., inventory peer nodes, mobile device nodes, computing device nodes, super nodes, server systems, gateways, legacy systems, agent systems, payment processing system, hosted inventory system, backup system, authentication system, deployment partner system, etc.) of the present invention embodiments may alternatively be implemented by any type of hardware and/or other processing circuitry.

The various functions of the computing systems or devices (e.g., inventory peer nodes, mobile device nodes, computing device nodes, super nodes, server systems, gateways, legacy systems, agent systems, payment processing system, hosted inventory system, backup system, authentication system, deployment partner system, etc.) may be distributed in any manner among any quantity of software modules or units, processing or computing systems or devices and/or circuitry, where the computing or processing systems or devices may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various nodes of the network topology (e.g., inventory peer nodes, mobile device nodes, computing device nodes, super nodes, server systems, gateways, legacy systems, agent systems, payment processing system, hosted inventory system, backup system, authentication system, deployment partner system, etc.). The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., inventory peer module, user interface module, core module, user interaction module, inventory management module, network connectivity module, install module and other modules for inventory management, etc.) may be available on a program product apparatus or device including a recordable or computer usable or readable medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

The communication network may be implemented by any quantity of any type of communications network (e.g., LAN, WAN, Internet, Intranet, VPN, etc.). The computing systems or devices (e.g., inventory peer nodes, mobile device nodes, computing device nodes, super nodes, server systems, gateways, legacy systems, agent systems, payment processing system, hosted inventory system, backup system, authentication system, deployment partner system, etc.) of the present invention embodiments may include any conventional or other communications devices to communicate over the network via any conventional or other protocols. The computing systems or devices (e.g., inventory peer nodes, mobile device nodes, computing device nodes, super nodes, server systems, gateways, legacy systems, agent systems, payment processing system, hosted inventory system, backup system, authentication system, deployment partner system, etc.) may utilize any type of connection (e.g., wired, wireless, etc.) for access to the network.

The various storage units (e.g., of the network (e.g., inventory peer nodes, backup system, hosted inventory system, etc.), databases, etc.) may be implemented by any number of any conventional or other databases, data stores or storage structures (e.g., files, databases, data structures, data or other repositories, etc.) to store any suitable information (e.g., information pertaining to the inventory, information pertaining to transactions, bookings, reservations, cancellations, sales, pricing, financial information, payment information, credits, information for the inventory modules, information of the inventory provider, etc.). The storage units may be included within or coupled to the various nodes, and may be remote from or local to the nodes.

The peer-to-peer network may be utilized for management of any type of inventory including any types of goods and/or services. For example, items having time or other resource constraints (e.g., items that are available only for defined periods of time, items having conditions attached to availability and/or use of the item). By way of example only, the types of inventories may include: services that can be booked in advance (e.g., guided tours, restaurant reservations, hotel rooms, car rentals, airline seats and the like), rentals of physical items (e.g., rental of vacation properties, rentals of apartment or other dwelling units, rental of commercial real estate, rental of machines or equipment, and the like), sale of retail or wholesale products, particularly those having a time sensitivity (e.g., cars, clothing, parts produce, and the like), simple personal items for sale (e.g., online auctions, etc.), or any other product and/or service, The inventory information for an inventory provider may be defined and stored on any quantity of inventory peer nodes or any other nodes, systems and/or devices in the network. The network may include any suitable infrastructure or topology, where there is distributed processing and/or at least two nodes may perform peer-to-peer communications.

Although present invention embodiments refer to consumers and inventory providers, the inventory may be made available, accessed, transacted, and/or consumed by any suitable user (e.g., owner, provider, end-user or individual, consumer, an intermediary or agent where the party making the purchase and/or publishing inventory is actually not the provider or end consumer, etc.) from any suitable node or device within or coupled to the network (e.g., direct or indirect access node, inventory peer node, etc.). The transactions for the inventory may be conducted between any suitable parties (e.g., business to consumer, consumer to business, business to business, consumer to consumer, etc.). The encrypted network may employ any quantity of any computer or other processing systems or devices arranged in any fashion to encrypt communications between network participants. The messages or other information may be encrypted or encoded via any conventional or other encryption techniques. The super or other nodes may route or direct messages within the peer-to-peer network in any desired fashion, and utilize any conventional or other techniques.

The present invention embodiments may employ any number of any type of user interface (e.g., Graphical User Interface (GUI), command-line, prompt, etc.) for obtaining or providing information (e.g., obtaining information for the inventory, obtaining information for search requests and providing results, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion. The interfaces may display a list of inventory peer nodes responding to requests, and/or the relevant inventory information may be automatically retrieved from those nodes and displayed (e.g., without selection of specific nodes by a user).

The inventory may be backed up at any desired time intervals (e.g., specified time, daily, weekly, monthly, on command, etc.). The inventory may be hosted by any suitable computing or other processing system or device that is within or external of the network. The inventory may alternatively be hosted by any suitable storage unit that is within or external of the network. The inventory may be migrated to or from the hosted inventory system in response to any suitable conditions (e.g., node or hosted inventory system failure, on command, at specified times, etc.).

Any suitable quantity of credits may be required to enable access to inventory information, where each transaction may have an associated cost of one or more credits. An inventory provider may be required to have any desired minimum quantity of credits prior to enabling access to inventory information. Alternatively, access may be provided without use of credits. The credit information may be stored and processed on any suitable computing or processing system or device within or external of the network. The payment deadline may be set to provide any suitable time interval for rendering payment (e.g., hours, days, weeks, months, etc.). Payment may be provided manually, electronically, or in any other manner (e.g., over the counter at a retail establishment, ATM or other device, mailing of payment, etc.), and may be tendered via any suitable instrument (e.g., cash via Seven Eleven, Western Union, ATM's, etc.), check, credit/debit card, etc.). The various messages and requests (e.g., search requests, inventory requests, messages, electronic mail, etc.) may include any information arranged in any fashion (e.g., search criteria, instructions for payment, confirmations, invalidations, payment or other deadlines, etc.).

The network may enable any suitable legacy systems (e.g., online travel sites, global distribution systems, other systems managing inventory, etc.) to access the inventory information. The access gateway may receive requests from and/or provide information to agent systems, consumer computing or processing systems or devices, legacy distribution channels, network nodes, etc. The information from the legacy systems and network may be merged and/or displayed in any fashion or arrangement.

The authentication for the inventory peer module may be performed at any suitable times (e.g., download, install, configure, periodically after installation, etc.). The authentication information may include any desired information (e.g., user or node attributes, passcodes, PIN, user or module identifications, etc.) to authenticate the inventory peer module, inventory provider, or network participant. The authentication may similarly be performed for any of the inventory modules, network nodes or participants. The authentication may be performed by any system or node (e.g., peer nodes, authentication system, etc.) internal or external of the network via any suitable processing (e.g., online transactions, etc.). The authentication may be performed for any network participants regardless of whether they are associated with a deployment partner. The deployment partner may be any association, group, or any other organization. The modules may be available for downloading from any suitable computing or storage device within or external of the network, and/or may be available on a program product apparatus or device including a recordable or computer usable or readable medium (e.g., magnetic or optical mediums, magneto-optic mediums, CD-ROM, DVD, memory devices, etc.) that may be distributed in any desired fashion.

The network may provide communications between buyer, seller, and/or an intermediary via any conventional or other techniques (e.g. electronic mail, chat, Voice Over IP (VOIP), whiteboard, etc.) before, during and/or after a transaction. The inventory can be “cascaded”, where the extensive integrated communications capabilities available allow for the network to transparently integrate the inventory into multiple levels of product definition and distribution (e.g., room inventory may be placed within a package, where multiple inventoried and non-inventoried products may be statically or dynamically combined into a single package). The price quote may include any desired information (e.g., price, predetermined time interval, etc.), where the predetermined time interval for response may be set to any desired time interval (e.g., hours, days, weeks, months, etc.). The inventory information may be published in whole or any specific parts to participants within and/or external of the network. The inventory information may include any desired information concerning the inventory (e.g., information pertaining to the inventory, transactions for the inventory, bookings, reservations, payments, cancellations, sales, financials, pricing, etc.).

It is to be understood that the terms “top”, “bottom”, “front”, “rear”, “side”, “height”, “length”, “width”, “upper”, “lower”, “vertical” and the like are used herein merely to describe points of reference and do not limit the present invention to any particular orientation or configuration. It will be further understood that the terms “comprises”, “comprising”, “includes”, “including”, “has”, “have”, “having”, “with” and the like, when used herein, specify the presence of stated features, and do not preclude the presence or addition of one or more other features.

The present invention embodiments are not limited to the specific tasks or algorithms described above, but may be utilized for managing any type of inventory or other information on a network with at least a portion providing distributed processing and/or peer-to-peer communication.

From the foregoing description, it will be appreciated that the invention makes available a novel a method and system for inventory management over a peer-to-peer network, wherein inventory information is published and managed over a peer-to-peer network.

Having described preferred embodiments of a new and improved method and system for inventory management over a peer-to-peer network, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A computer-based node within a communications network to manage inventory comprising:
a computer system operably configured to manage inventory on said communications network, wherein the computer system comprises:
a user interface module to provide a user interface customized for inventory of a user to receive inventory information pertaining to said inventory and one or more desired operations from said user; and
a core module to provide access to said inventory information from said communications network and process one or more requests received from at least one other node within said communications network for said inventory information, wherein at least a portion of said communications network provides peer-to-peer communication and said requests for said inventory information are received from said at least one other node via said peer-to-peer communication.

2. The node of claim 1, wherein said core module includes:
a user interaction module that enables interaction with said user via said user interface;
an inventory management module that processes said user interaction and said requests from said at least one other node and stores and retrieves said inventory information; and
a network connectivity module that provides communications between said node and said communications network.

3. The node of claim 1, wherein said computer system further includes:
an inventory module to migrate said inventory information from said node to an inventory system that hosts said inventory information to enable access to said inventory information from said communications network in response to said node being offline.

4. The node of claim 1, wherein said computer system further includes:
an inventory module to generate a backup data file containing said inventory information and store said copy on a backup system to enable restoration of said inventory information in response to data loss.

5. The node of claim 1, wherein said computer system further includes:
an inventory module to purchase one or more credits in response to a user request to enable processing of said requests from said at least one other node within said communications network.

6. The node of claim 1, wherein said inventory information is dynamically changing based on said processed requests, and said peer-to-peer communication enables retrieval of the most current inventory information from said node.

7. The node of claim 1, wherein said inventory includes at least one of goods and services.

8. The node of claim 1, wherein said operations include at least one of editing said inventory information, selling said inventory, migrating said inventory information to a host system, and reviewing a transaction for said inventory.

9. The node of claim 1, wherein said inventory information is immediately available to said communications network in response to entry of that information into said node.

10. A computer-implemented method for managing inventory on a node within a communications network comprising:
(a) displaying a user interface customized for inventory of a user to receive inventory information pertaining to said inventory and one or more desired operations from said user; and
(b) enabling access to said inventory information from said communications network and processing one or more requests received from at least one other node within said communications network for said inventory information, wherein at least a portion of said communications network provides peer-to-peer communication and said requests for said inventory information are received from said at least one other node via said peer-to-peer communication.

11. The computer-implemented method of claim 10, wherein step (b) further includes:
(b.1) processing user interaction with said user interface and said requests from said at least one other node and storing and retrieving said inventory information; and
(b.2) establishing communications between said node and said communications network.

12. The computer-implemented method of claim 10, further including:
(c) migrating said inventory information from said node to an inventory system that hosts said inventory information to enable access to said inventory information from said communications network in response to said node being offline.

13. The computer-implemented method of claim 10, further including:
(c) generating a backup data file containing said inventory information and storing said copy on a backup system to enable restoration of said inventory information in response to data loss.

14. The computer-implemented method of claim 10, further including:
(c) obtaining one or more credits in response to a user request to enable processing of said requests from said at least one other node within said communications network.

15. The computer-implemented method of claim 10, wherein said inventory information is dynamically changing based on said processed requests, and said peer-to-peer communication enables retrieval of the most current inventory information from said node.

16. The computer-implemented method of claim 10, wherein said inventory includes at least one of goods and services.

17. The computer-implemented method of claim 10, wherein said operations include at least one of editing said inventory information, selling said inventory, migrating said inventory information to a host system, and reviewing a transaction for said inventory.

18. The computer-implemented method of claim 10, wherein step (b) further includes:
(b.1) enabling said inventory information to be immediately available to said communications network in response to entry of that information into said node.

19. A program product apparatus including a computer readable medium with computer program logic recorded thereon for managing inventory on a node within a communications network, said program product apparatus comprising:
a user interface module to provide a user interface customized for inventory of a user to receive inventory information pertaining to said inventory and one or more desired operations from said user; and
a core module to provide access to said inventory information from said communications network and process one or more requests received from at least one other node within said communications network for said inventory information, wherein at least a portion of said communications network provides peer-to-peer communication and said requests for said inventory information are received from said at least one other node via said peer-to-peer communication.

20. The program product apparatus of claim 19, wherein said core module includes:
a user interaction module that enables interaction with said user via said user interface;
an inventory management module that processes said user interaction and said requests from said at least one other node and stores and retrieves said inventory information; and
a network connectivity module that provides communications between said node and said communications network.

21. The program product apparatus of claim 19, further including:
an inventory module to migrate said inventory information from said node to an inventory system that hosts said inventory information to enable access to said inventory information from said communications network in response to said node being offline.

22. The program product apparatus of claim 19, further including:
an inventory module to generate a backup data file containing said inventory information and store said copy on a backup system to enable restoration of said inventory information in response to data loss.

23. The program product apparatus of claim 19, further including:
an inventory module to purchase one or more credits in response to a user request to enable processing of said requests from said at least one other node within said communications network.

24. The program product apparatus of claim 19, wherein said inventory information is dynamically changing based on said processed requests, and said peer-to-peer communication enables retrieval of the most current inventory information from said node.

25. The program product apparatus of claim 19, wherein said inventory includes at least one of goods and services.

26. The program product apparatus of claim 19, wherein said operations include at least one of editing said inventory information, selling said inventory, migrating said inventory information to a host system, and reviewing a transaction for said inventory.

27. The program product apparatus of claim 19, wherein said inventory information is immediately available to said communications network in response to entry of that information into said node.

28. A communications network to manage inventory comprising:
at least one inventory node each including a computer system to provide a user interface customized for inventory of a user for receiving inventory information pertaining to said inventory and one or more desired operations from said user, to provide access to said inventory information from said communications network, and to process one or more requests received from at least one other node within said communications network for said inventory information;
at least one super node to manage communications within said network and direct said requests to appropriate ones of said inventory nodes; and
at least one access node to transmit said requests to one or more of said inventory nodes for desired inventory information and to conduct transactions for said inventory, wherein at least a portion of said communications network provides peer-to-peer communication with one or more of said inventory nodes and said requests for said inventory information are transmitted to said appropriate inventory nodes via said peer-to-peer communication.

29. The communications network of claim 28, wherein said inventory includes at least one of goods and services.

30. The communications network of claim 28, wherein said communications network is a public network, and further includes:
an encrypted network to encrypt communications between said inventory, super, and access nodes to provide encrypted communications within said communications network.

31. The communications network of claim 28, wherein access to at least one inventory node is restricted by a firewall, and wherein said at least one super node obviates said firewall to enable at least one access node to communicate with said at least one restricted inventory node.

32. The communications network of claim 28, further including:
a payment system to handle payments for purchasing inventory from said at least one inventory node.

33. The communications network of claim 28, further including:
a host inventory system to host said inventory information from one or more inventory nodes to enable access to that inventory information in response to said one or more inventory nodes being offline.

34. The communications network of claim 28, further including:
a backup system to backup said inventory information of one or more inventory nodes for subsequent restoration of said inventory information

35. The communications network of claim 28, wherein said inventory information of said at least one inventory node is dynamically changing based on said processed requests, and said peer-to-peer communication enables retrieval of the most current inventory information from said at least one inventory node.

36. The communications network of claim 28, wherein at least one access node includes a computing device to directly request information from one or more of said inventory nodes via said peer-to-peer communication and to conduct transactions for said inventory.

37. The communications network of claim 28, wherein at least one access node includes a server system and a web site to transmit said requests to one or more of said inventory nodes for desired inventory information via said peer-to-peer communication and to conduct transactions for said inventory.

38. The communications network of claim 28, wherein at least one access node includes a gateway device coupled to a legacy inventory system providing inventory information, wherein said gateway device transmits requests between said legacy system and one or more of said inventory nodes for desired inventory information via said peer-to-peer communication and conducts transactions for said desired inventory.

39. The communications network of claim 28, wherein access of said inventory information of an inventory node from said communications network and performance of said transactions is enabled in response to the presence of a sufficient quantity of transaction credits for a corresponding inventory provider.

40. The communications network of claim 28, wherein said operations of said at least one inventory node include at least one of editing said inventory information, selling said inventory, migrating said inventory information to a host system, and reviewing a transaction for said inventory.

41. The communications network of claim 28, wherein said inventory information is immediately available to said communications network in response to entry of that information into at least one inventory node.

42. A method for managing inventory on a communications network, wherein said communications network includes at least one inventory node, at least one super node, and at least one access node, said method comprising:
(a) receiving, at said at least one inventory node on a user interface customized for inventory of a user, inventory information pertaining to said inventory and one or more desired operations from said user and providing access to said inventory information from said communications network;
(b) transmitting one or more requests from said at least one access node to one or more of said inventory nodes for desired inventory information and conducting transactions for said inventory;
(c) managing communications within said network via said at least one super node and directing said requests to appropriate ones of said inventory nodes; and
(d) processing, at said at least one inventory node, said one or more requests received from said at least one access node within said communications network for said inventory information, wherein at least a portion of said communications network provides peer-to-peer communication with one or more of said inventory nodes and said requests for said inventory information are transmitted to said appropriate inventory nodes via said peer-to-peer communication.

43. The method of claim 42, wherein said inventory includes at least one of goods and services.

44. The method of claim 42, wherein said communications network is a public network, and step (c) further includes:
(c.1) encrypting communications between said inventory, super, and access nodes via an encrypted network within said communications network to provide encrypted communications within said communications network.

45. The method of claim 42, wherein access to at least one inventory node is restricted by a firewall, and wherein step (c) further includes:
(c.1) obviating said firewall, via at least one super node, to enable at least one access node to communicate with said at least one restricted inventory node.

46. The method of claim 42, further including:
(e) processing payments for purchasing inventory from said at least one inventory node.

47. The method of claim 42, further including:
(e) hosting said inventory information from one or more inventory nodes on a host system to enable access to that inventory information in response to said one or more inventory nodes being offline.

48. The method of claim 42, further including:
(e) storing said inventory information of one or more inventory nodes on a backup system for subsequent restoration of said inventory information

49. The method of claim 42, wherein said inventory information of said at least one inventory node is dynamically changing based on said processed requests, and said peer-to-peer communication enables retrieval of the most current inventory information from said at least one inventory node.

50. The method of claim 42, wherein at least one access node includes a computing device, and step (b) further includes:
(b.1) directly requesting information from one or more of said inventory nodes via said computing device performing said peer-to-peer communication with said one or more inventory nodes and conducting transactions for said inventory.

51. The method of claim 42, wherein at least one access node includes a server system and a web site, and step (b) further includes:
(b.1) transmitting requests to one or more of said inventory nodes for desired inventory information via said server system performing said peer-to-peer communication with said one or more inventory nodes and conducting transactions for said inventory.

52. The method of claim 42, wherein at least one access node includes a gateway device coupled to a legacy inventory system providing inventory information, and step (b) further includes:
(b.1) transmitting requests between said legacy system and one or more of said inventory nodes for desired inventory information via said gateway device performing peer-to-peer communication with said one or more inventory nodes and conducting transactions for said desired inventory.

53. The method of claim 42, wherein step (d) further includes:
(d.1) enabling access of said inventory information of an inventory node from said communications network and performance of said transactions in response to the presence of a sufficient quantity of transaction credits for a corresponding inventory provider.

54. The method of claim 42, wherein said operations of said at least one inventory node include at least one of editing said inventory information, selling said inventory, migrating said inventory information to a host system, and reviewing a transaction for said inventory.

55. The method of claim 42, wherein step (a) further includes:
(a.1) enabling said inventory information to be immediately available to said communications network in response to entry of that information into said at least one inventory node.

56. The node of claim 1, wherein said computer system further includes:
an install module to authenticate said user via an authentication system in response to said user being affiliated with an organization, wherein said authentication occurs prior to complete installation of said user interface module and said core module on said computer system.

57. The node of claim 56, wherein said install module retrieves information pertaining to at least one of said user and said inventory from a computer system of said organization, wherein said information was previously provided to said organization computer system by said user for said organization.

58. The computer-implemented method of claim 10, wherein step (a) further includes:
(a.1) authenticating said user via an authentication system in response to said user being affiliated with an organization.

59. The computer-implemented method of claim 58, wherein step (a) further includes:
(a.2) retrieving information pertaining to at least one of said user and said inventory from a computer system of said organization, wherein said information was previously provided to said organization computer system by said user for said organization.

60. The program product apparatus of claim 19, further including:
an install module to authenticate said user via an authentication system in response to said user being affiliated with an organization, wherein said authentication occurs prior to complete installation of said user interface module and said core module on a computer system.

61. The program product apparatus of claim 60, wherein said install module retrieves information pertaining to at least one of said user and said inventory from a computer system of said organization, wherein said information was previously provided to said organization computer system by said user for said organization.

62. The communications network of claim 28, further including:
an authentication system to authenticate said user in response to said user being affiliated with an organization, wherein said authentication occurs prior to complete installation of modules on said computer system of a corresponding inventory peer node.

63. The communications network of claim 62, further including:
an organization system to store information for said organization pertaining to at least one of said user and said inventory, wherein said information is accessible to a corresponding inventory node to avoid duplicate entry of information.

64. The method of claim 42, wherein step (a) further includes:
(a.1) authenticating said user in response to said user being affiliated with an organization.

65. The method of claim 64, wherein step (a) further includes:
(a.2) storing information for said organization pertaining to at least one of said user and said inventory on an organization computer system, wherein said information is accessible to a corresponding inventory node to avoid duplicate entry of information.
